(19) United States
(12) Patent Application Publication
(10) Pub. No.: US 2005/0155289 A1
(43) Pub. Date: Jul. 21, 2005

(54) Power lift gate actuator

(76) Inventor: G. Clarke Oberheide, Troy, MI (US)

Correspondence Address: Robin W Asher;Clark Hill, Suite 3500, 500 Woodward Avenue, Detroit, MI, 48226-3435, US

(21) Appl. No.: 10/501,662

(22) PCT Filed: Jan. 24, 2003
(86) PCT No.: PCT/CA03/00101

Related U.S. Application Data
(60) Provisional application No. 60/351,571, filed on Jan. 24, 2002.

(51) Int. Cl. E05F 15/02

(52) U.S. Cl. 49/340

(57) ABSTRACT

A liftgate actuating assembly is disclosed for moving a liftgate of a motor vehicle between open and closed positions. The liftgate actuating assembly includes a motor that is fixedly secured to the motor vehicle. The motor has an output shaft capable of bi-directional rotation. A drive gear rotates about a drive shaft and is operatively connected to the output shaft to be rotated thereby. A cable drum is rotatably mounted to the drive shaft. The cable drum is coupled to the drive gear and is rotated thereby. The cable drum includes a cable wrapped thereabout between a drum end fixedly secured to the cable drum and a liftgate end fixedly secured to the liftgate. The cable is used to retract the liftgate from the open position to the closed position. A linkage is operatively connected to the drive gear. The linkage is from a retracted position to an extended position such that the linkage forces the liftgate from the closed position to the open position when the linkage moves from the retracted position to the extended position. The linkage includes a slot that provides lost motion within the linkage. This allows the liftgate to be move manually to the closed position without the motor being activated.

### FIELD OF THE INVENTION

The invention relates to a system liftgate for a motor vehicle. In particular, the invention relates to an actuator used to assist in the movement of the liftgate of the motor vehicle between open and closed positions.

### DESCRIPTION OF THE RELATED ART

As motor vehicles characterized by their utility become a mainstream choice, consumers demand certain luxuries primarily associated with passenger cars, either due to their inherent design and/or size. One of the features desired by consumers is the automated movement of such items as sliding doors and liftgates. While features providing automated motion are available, they are often cumbersome and add undue weight to the motor vehicle.

U.S. Pat. No. 6,318,025 discloses one such device. This patent discloses a system for power operating a liftgate. The liftgate utilizes a gas spring strut counterbalance system to aid in the opening of the liftgate once the opening has begun. The power operating system includes at least one drive unit that includes a reversible electric motor, a spool driven by the electric motor, a flexible belt that has one end attached to the spool and an opposite end attached to the liftgate, and a push member that is driven by the electric motor between a retracted position and an extended position. To raise liftgate from the closed position to the open position, the bottom of liftgate 12 is unlatched and motor is energized to rotate an output shaft counterclockwise. This engages overrunning clutches and drives sprockets counter clockwise to extend the push member, which pushes the liftgate to a partially open position. When the liftgate opens a predetermined amount, the opening force of the gas spring struts completes the opening of the liftgate to the fully open position shown in FIGS. 1 and 4. During this opening movement, the belt is payed off the spool by the freewheeling of spool 28 when being pulled by the opening tailgate.

To close the liftgate, the motor is energized to rotate the output shaft clockwise. This engages overrunning clutch and drives drum clockwise to wind the web onto the spool, which pulls the liftgate to the closed position. The closing liftgate also retracts the push member. The push member can be retracted because the freewheeling clutch allows the push member to move with respect to the output shaft. This power operating system requires a plurality of clutches to make operate in both automatic and manual modes.

### SUMMARY OF THE INVENTION

A liftgate actuating assembly is disclosed for moving a liftgate of a motor vehicle between open and closed positions. The liftgate actuating assembly includes a motor that is fixedly secured to the motor vehicle. The motor has an output shaft capable of bi-directional rotation. A drive gear rotates about a drive shaft and is operatively connected to the output shaft to be rotated thereby. A cable drum is rotatably mounted to the drive shaft. The cable drum is coupled to the drive gear and is rotated thereby. The cable drum includes a cable wrapped thereabout between a drum end fixedly secured to the cable drum and a liftgate end fixedly secured to the liftgate. The cable is used to retract the liftgate from the open position to the closed position. A linkage is operatively connected to the drive gear. The linkage is from a retracted position to an extended position such that the linkage forces the liftgate from the closed position to the open position when the linkage moves from the retracted position to the extended position. The linkage includes a slot that provides lost motion within the linkage. This allows the liftgate to be move manually to the closed position without the motor being activated.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention in a motor vehicle, partially cut away;

FIG. 2 is a perspective view of the invention with a portion of the housing removed;

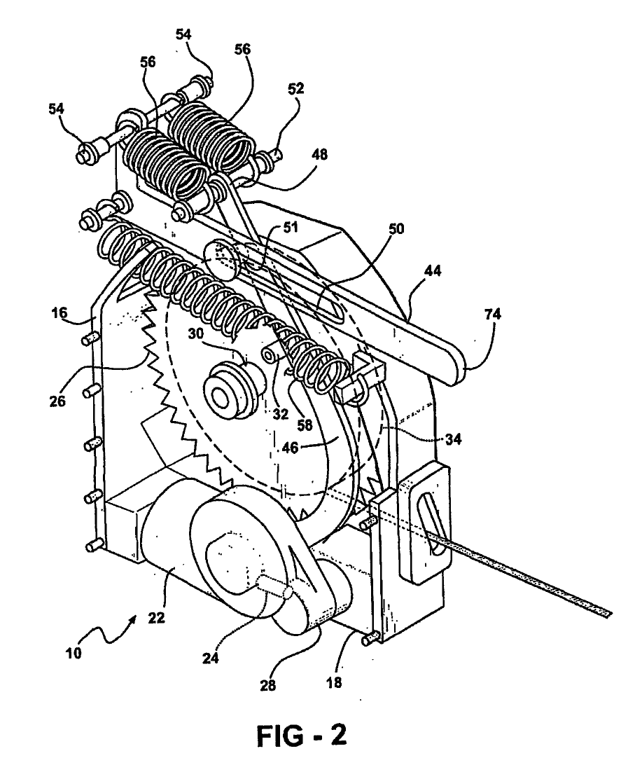

FIG. 3 is a perspective view of the invention with a portion of the housing removed; and

FIG. 4 is a perspective view of the invention with a rod retracted due to manual closure of the liftgate; and

FIG. 5 is a schematic drawing of one embodiment of the control circuit incorporated by the invention.

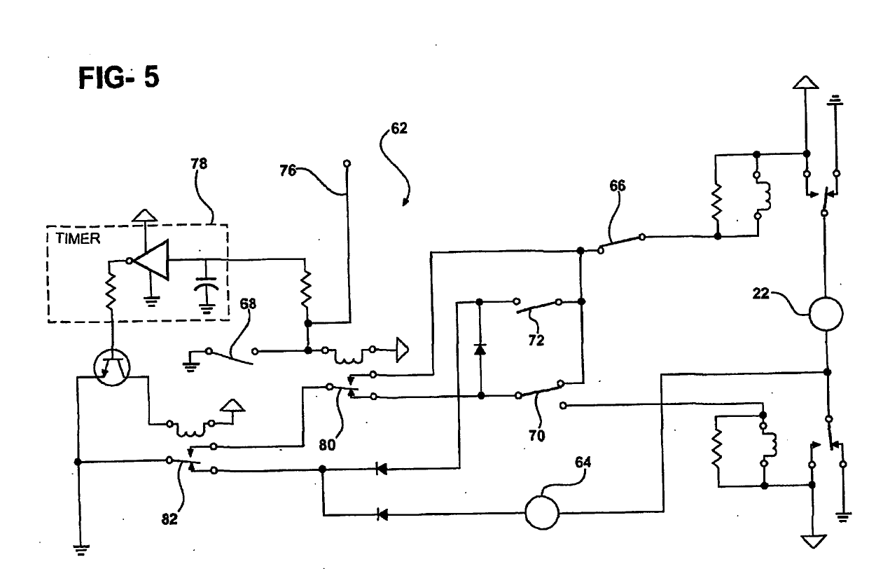

### DETAILED DESCRIPTION OF THE PREFERRED EMBODIMENTS

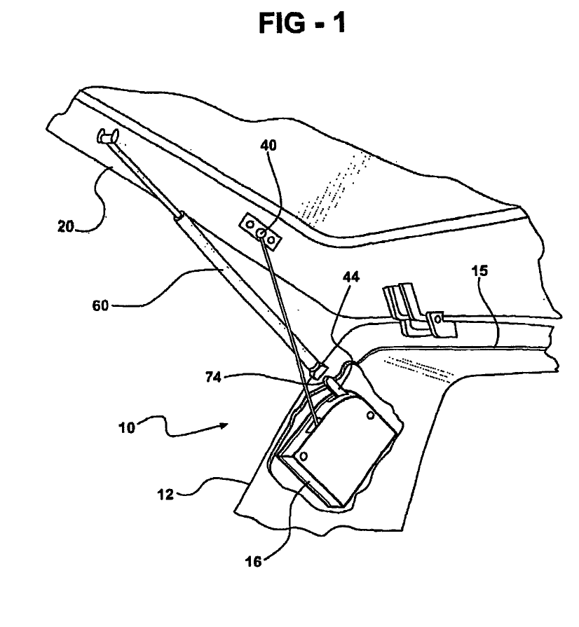

Referring to the Figures, a liftgate actuating assembly is generally indicated at 10. The liftgate actuating assembly 10 is mounted to a rear pillar 12 of the motor vehicle 14 adjacent an opening 15 in the motor vehicle 14. The liftgate actuating assembly 10 includes a housing 16 having a base 18 that is fixedly secured to the rear pillar 12. The liftgate actuating assembly 10 moves a liftgate 20 between its closed position and its open position, shown in FIG. 1. More specifically, the liftgate actuating assembly 10 initiates movement of the liftgate 20 away from its closed position and completely returns the liftgate 20 to the closed position from the open position. The liftgate actuating assembly 10 does not completely move the liftgate 20, but initiates the movement thereof.

The liftgate actuating assembly 10 is connected to an electrical source and receives power therefrom. A motor 22 receives the electric power and converts it into rotational motion. The motor 22 rotates an output shaft 24. The output shaft 24 is operatively connected to a drive gear 26. A drive transmission 28, including a plurality of gears (not shown) extends between the output shaft 24 and the drive gear 26 to facilitate the proper force and direction of the rotational power that is to be received by the drive gear 26. The drive gear 26 rotates about a drive shaft 30. A roller bearing 32 is fixedly secured to the drive gear 26 and will be discussed in greater detail subsequently.

The liftgate actuating assembly 10 also includes a cable drum 34. The cable drum 34 is rotatably connected to the drive shaft 30 of the drive gear 26. More specifically, the cable drum 34 and the drive gear 26 are coaxial. The cable drum 34 and the drive gear 26 are coupled and rotate in unison at times. At other times, the drive gear 26 and the cable drum 34 are not coupled, allowing the cable drum 34 to rotate independently of the drive gear 26.

A cable 36 extends between a drum end (not shown) and a liftgate end 40. The drum end is fixedly secured to the cable drum 34 whereas the liftgate end 40 is fixedly secured to the liftgate 20. The cable 36 is substantially wrapped around the cable drum 34 when the liftgate 20 is in its closed position.

The liftgate actuating assembly 10 includes a connecting device, generally shown at 42. The connecting device is a linkage 42 that includes a plurality of links 44, 46. In another embodiment, the connecting device 42 may include a second cable (not shown) that is configured to initiate the opening of the liftgate 20.

In the embodiment shown in the Figures, the linkage 42 has two elements, a rod 44 and a curvilinear arm 46. The curvilinear arm 46 is pivotally secured with respect to the housing 16. In one embodiment, the curvilinear arm 46 may pivot about an axle in the drive transmission 28. A second end 48 of the curvilinear arm 46 is connected to the rod 44. The rod 44 is generally linear and defines a slot 50 that extends along a portion thereof. A pin, represented by its head 51, extends out from the curvilinear arm 46 perpendicularly thereto. The pin 51 is received by the slot 50 allowing the pin 51 to travel therealong. Therefore, lost motion is possible between the second end 48 of the curvilinear arm 46 and the rod 44.

Extending out from the second end 48 and the rod 44 are an arm mount 52 and a rod mount 54, respectively. The arm 52 and rod 54 mounts are interconnected by two springs 56. The two springs 56 minimize the lost motion between the second end 48 and the rod 44.

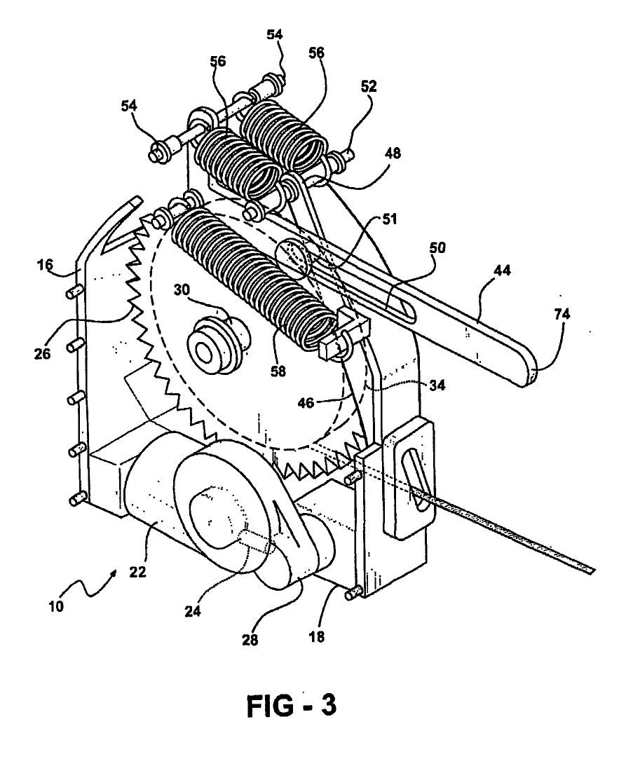

A bias spring 58 is mounted between the rod mount 54 and the housing 16. The bias spring 58, partially cut away in FIG. 3, biases the rod 44 from a retracted position toward an extended position to facilitate the opening of the liftgate 20.

The rod 44 is extendable out of the housing 16. When the rod 44 moves toward its extended position, it abuts the liftgate 20 and forces the liftgate 20 out of its closed position and toward its open position. After the rod 44 is fully extended, lift assist struts 60 move the liftgate 20 to its open position. The lift assist struts 60 eliminate the need for much of the length of the rod 44. More specifically, the rod 44 need only to move the liftgate 20 a portion of the distance away from its closed position before the lift assist struts 60 move the liftgate toward its open position without further assistance from any other mechanism.

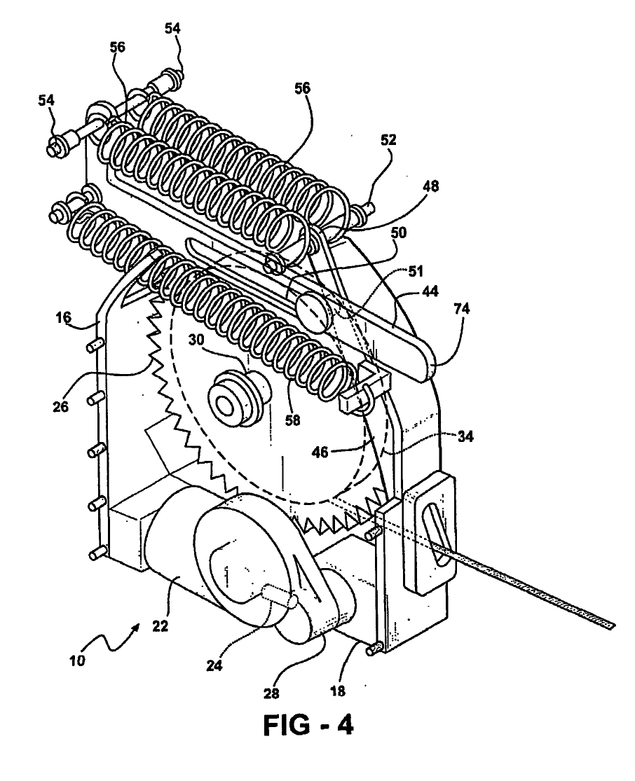

Referring to FIG. 4, an electrical control circuit is generally indicated at 62. As is typical for circuits in the motor vehicle environment, the electrical control circuit 62 operates off a twelve Volt DC power source. The electrical control circuit 62 controls the motor 22 and a latch motor 64. The latch motor 64 automates the cinching and unlatching of the liftgate 20.

The electrical control circuit 62 includes a park switch 66. The park switch 66 prevents the unlatching and movement of the liftgate 20 away from its closed position when the motor vehicle 14 is not in a parked state with its transmission in a parked condition.

The other two inputs are received from a latch switch 68 and a user switch 70. The latch switch 68 identifies whether a latch should be engaged or disengaged. The user switch 70 is a toggle switch allowing the user to identify whether the liftgate 20 is to move from one position to another.

The electric control circuit 62 operates in two modes, open and closed. In the open mode, the latch state is ignored and a motor hold open switch 72 prevents the motor 22 from cycling. This will be discussed in greater detail subsequently.

In operation and starting with the liftgate 20 in its closed position and cinched, the operator of the liftgate 20 toggles the user switch 70. The latch unlatches the liftgate 20 using the latch release motor 64. The motor 22 rotates the drive gear 26 which, in turn, moves the roller bearing 32 thereabout. The roller bearing 32 abuts and moves the curvilinear arm 46. Because the rod 44 and the curvilinear arm 46 are coupled via the springs 56, the rod 44 is forced to move axially toward its extended position. A distal end 74 of the rod 44 abuts the liftgate 20 and forces it out of its closed position toward its open position. Once moved sufficiently, the lift assist struts 60 become active and move the liftgate 20 to its open position.

The cable 36 is tied to the liftgate 20 and unwraps from the cable drum 34. The cable drum 34 moves independently of the drive gear 26 through this movement.

In this position, the liftgate 20 is in its open position and the rod 44 is in its extended position. The slot 50 allows manual closure of the liftgate 20 without damaging the rod 44. More specifically, the slot 50 allows for lost motion between the rod 44 and the curvilinear arm 46 should the liftgate 20 be closed manually by allowing the pin 51 to travel along the slot 50, thus providing a sufficient amount of play to allow the rod 44 to retract into the housing 16 and avoid damage by and to the liftgate 20.

Upon toggling the user switch 70, the liftgate actuating assembly 10 moves to close the liftgate 20. The motor 22 begins to move which rotates the drive gear 26. The drive gear 26 engages the cable drum 34 and begins to retract the cable 36 by having it wrap thereabout. The roller bearing 32 does not move the curvilinear arm 46 nor the rod 44 because the bias spring 58 prevents the retraction of the rod 44 until the liftgate 20 forces the distal end 74 back toward the housing 16. The bias spring 58 does not prevent the closing of the liftgate 20 because the distal end 74 cannot touch the liftgate 20 until it approaches the liftgate actuating assembly 10 and the rod 44 is retractable once engaged by the liftgate 20.

Upon closing, the latch switch 68 sends a signal through terminal 76 to the latch control circuit (not shown) that cinches the latch preventing the liftgate 20 from leaving its closed position. A timer circuit 78, triggered by a latch state relay 80, switches the control circuit 62 between open and closed operation modes by operating the operation mode relay 82. The operation mode relay 82 is shown in its closed position, which allows the liftgate 20 to be opened. It other state is required to close the liftgate 20.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

1. A liftgate actuating assembly for moving a liftgate of a motor vehicle between an open position and a closed position, said liftgate actuating assembly comprising:
a motor fixedly secured to the motor vehicle, said motor having an output shaft capable of bi-directional rotation;
a drive gear rotatable about a drive shaft, said drive gear operatively connected to said output shaft to be rotated thereby;
a cable drum rotatably mounted to said drive shaft, said cable drum coupled to said drive gear to be rotated thereby, said cable drum including a cable wrapped thereabout between a drum end fixedly secured to said cable drum and a liftgate end fixedly secured to the liftgate for retracting the liftgate from the open position to the closed position; and
a linkage operatively connected to said drive gear, said linkage movable from a retracted position to an extended position such that said linkage forces the liftgate from the closed position to the open position when said linkage moves from said retracted position to said extended position, said linkage including a slot providing lost motion within said linkage allowing the liftgate to be moved manually to the closed position without said motor being activated.

2. A liftgate actuating assembly as set forth in claim 1 wherein said linkage includes a curvilinear arm pivotally movable by said drive gear as said drive gear is driven by said motor to move said linkage to said extended position.

3. A liftgate actuating assembly as set forth in claim 2 wherein said linkage includes a rod having a distal end extending out from said liftgate actuating assembly and engagable with the liftgate.

4. A liftgate actuating assembly as set forth in claim 3 wherein said rod includes said slot.

5. A liftgate actuating assembly as set forth in claim 4 wherein said curvilinear arm includes an arm mount.

6. A liftgate actuating assembly as set forth in claim 5 wherein said rod includes a rod mount disposed opposite said distal end.

7. A liftgate actuating assembly as set forth in claim 6 including a spring mounted between said arm and rod mounts to bias said arm and rod mounts toward each other.

8. A liftgate assembly as set forth in claim 7 including a housing covering said drive gear and cable drum.

9. A liftgate assembly as set forth in claim 8 including a bias spring extending between said housing and said rod mount to bias said rod out toward said extended position.

10. A liftgate assembly as set forth in claim 9 including a roller bearing rotatably secured to said drive gear for abutting against said curvilinear arm to force said curvilinear arm to move said rod toward said extended position.

11. A liftgate actuating assembly for moving a liftgate of a motor vehicle between an open position and a closed position, said liftgate actuating assembly comprising:
a motor fixedly secured to the motor vehicle, said motor having an output shaft capable of bi-directional rotation;
a drive gear rotatable about a drive shaft, said drive gear operatively connected to said output shaft to be rotated thereby;
a cable drum rotatably mounted to said drive shaft, said cable drum coupled to said drive gear to be rotated thereby, said cable drum including a cable wrapped thereabout between a drum end fixedly secured to said cable drum and a liftgate end fixedly secured to the liftgate for retracting the liftgate from the open position to the closed position; and
a connecting device operatively connected to said drive gear, said connecting device movable from a retracted position to an extended position such that said connecting device forces the liftgate from the closed position to the open position when said connecting device moves from said retracted position to said extended position.

12. A liftgate assembly for selectively opening and closing an opening in a motor vehicle, said liftgate assembly comprising:
a liftgate pivotally secured to the motor vehicle, said liftgate movable between a closed position over the opening and an open position away from the opening providing access to the motor vehicle;
a motor fixedly secured to the motor vehicle and disposed adjacent the opening, said motor having an output shaft capable of bi-directional rotation;
a drive gear rotatable about a drive shaft, said drive gear operatively connected to said output shaft to be rotated thereby;
a cable drum rotatably mounted to said drive shaft, said cable drum coupled to said drive gear to be rotated thereby, said cable drum including a cable wrapped thereabout between a drum end fixedly secured to said cable drum and a liftgate end fixedly secured to the liftgate for retracting the liftgate from the open position to the closed position; and
a linkage operatively connected to said drive gear, said linkage movable from a retracted position to an extended position such that said linkage forces the liftgate from the closed position to the open position when said linkage moves from said retracted position to said extended position, said linkage including a slot providing lost motion within said linkage allowing the liftgate to be moved manually to the closed position without said motor being activated.

13. A liftgate actuating assembly as set forth in claim 12 wherein said linkage includes a curvilinear arm pivotally movable by said drive gear as said drive gear is driven by said motor to move said linkage to said extended position.

14. A liftgate actuating assembly as set forth in claim 13 wherein said linkage includes a rod having a distal end extending out from said liftgate actuating assembly and engagable with the liftgate.

15. A liftgate actuating assembly as set forth in claim 14 wherein said rod includes said slot.

16. A liftgate actuating assembly as set forth in claim 15 wherein said curvilinear arm includes an arm mount.

17. A liftgate actuating assembly as set forth in claim 16 wherein said rod includes a rod mount disposed opposite said distal end.

18. A liftgate actuating assembly as set forth in claim 17 including a spring mounted between said arm and rod mounts to bias said arm and rod mounts toward each other.

19. A liftgate assembly as set forth in claim 18 including a housing covering said drive gear and cable drum.

20. A liftgate assembly as set forth in claim 19 including a bias spring extending between said housing and said rod mount to bias said rod out toward said extended position.
